(19) United States
(12) Patent Application Publication
(10) Pub. No.: US 2010/0035202 A1
(43) Pub. Date: Feb. 11, 2010

(54) SYSTEMS AND KITS FOR PROMOTING AND MAINTAINING ORAL HEALTH

(75) Inventors: Tim Clarot, Phoenix, AZ (US); Regina Miskewitz, Phoenix, AZ (US); Samuel Belcher, Moscow, OH (US); Louis Germanio, JR., Vineland, NJ (US); Jeffrey Rice, Dayton, OH (US)

Correspondence Address: SNELL & WILMER L.L.P. (Main), 400 EAST VAN BUREN, ONE ARIZONA CENTER, PHOENIX, AZ, 85004-2202, US

(73) Assignee: ZICARE, LLC, Scottsdale, AZ (US)

(21) Appl. No.: 12/300,989

(22) PCT Filed: May 15, 2007
(86) PCT No.: PCT/US07/69000

§ 371 Date: Jun. 12, 2009

Related U.S. Application Data
(60) Provisional application No. 60/800,638, filed on May 15, 2006.
(60) Provisional application No. 60/800,631, filed on May 15, 2006.
(60) Provisional application No. 60/863,913, filed on Nov. 1, 2006.

(51) Int. Cl. A61C 19/06

(52) U.S. Cl. 433/80

(57) ABSTRACT

Systems and kits dispensing material and methods of forming and using the systems and kits are disclosed. The system may include a deformable vessel portion for storing material and a spout portion for directing the material as the material is dispensed from the system. The vessel portion and the spout portion may be formed separately and subsequently coupled together to form the system.

### FIELD OF INVENTION

The present invention generally relates to assemblies for storing and dispensing materials. More particularly, the invention relates to assemblies for sealing material within a container and for controllably dispensing material from the container, to systems including the assemblies, and to methods of using and forming the assemblies and systems.

### BACKGROUND OF THE INVENTION

Many containers for storing and dispensing material are known. For example, sealed containers formed of resilient material, such as foil or plastic, are known. Material is often dispensed from such containers by rupturing (e.g., tearing) a portion of the container and squeezing a portion of the container to cause the material to flow through the ruptured portion of the container.

Although these containers work well for several applications, they may be deficient for use in some applications. For example, the rupturing or tearing of the container can be unpredictable, which leads to an unpredictable opening in the container. As a result, flow and placement of material extruded from the container may be unpredictable and/or difficult to control.

Accordingly, improved containers and systems including the containers are desired.

### SUMMARY OF THE INVENTION

The present invention provides an improved assembly, system including one or more assemblies, and methods of using and forming assemblies and systems. More particularly, the invention provides an assembly for controllably dispensing material from a sealable container and a system including the assembly and material to be dispensed. The assembly and system of the present invention can be used in a variety of applications and are conveniently described herein in the context of sealably containing and delivering a material including an active ingredient to a desired location.

While the ways in which the present invention addresses the disadvantages of the prior art will be discussed in greater detail below, in general, the present invention provides a convenient, easy-to-assemble sealable assembly, which allows precise dispensing of material to a desired location.

In accordance with various examples of embodiments of the invention, an assembly includes a vessel portion, including a resilient, deformable vial, a neck and a spout portion including a cap and a spout. In accordance with some aspects of this embodiment, the assembly includes a separately-formed spout portion that sealably attaches to the vessel portion to form a dispensing assembly.

In accordance with one embodiment of the invention, a vessel portion and a spout portion of an assembly are detachably coupled together. In accordance with various aspects of the embodiment, a neck of the vessel portion and a cap of the spout portion are configured to threadedly couple together. In accordance with another aspect, the cap portion includes a sealing flange to form a detachable seal with the neck of the vessel portion. In accordance with other aspects, the neck and cap engage each other, using lug, snap fit, or similar techniques, to form a seal between the vessel and spout portions. And, in accordance with yet further aspects, once the vessel portion and the spout portion are coupled, the portions are sealed using, the sealing flange, a sealant, by heat sealing the two portions together, and/or the like.

In accordance with an alternative embodiment of the invention, the cap of the spout portion rotatably couples to the neck of the vessel portion to form a rotatable seal between the vessel portion and the cap portion. In accordance with one aspect of this embodiment, one of the neck and the cap includes a first protrusion (e.g., a ring) and the other of the neck and the cap includes a recess for receiving the first protrusion. In accordance with other aspects, the vessel and the spout portions interference fit or snap-fit together to form a rotatable seal between the vessel portion and the spout portion. In accordance with yet another aspect of this embodiment, the neck includes a second protrusion (a capping ring) to facilitate handling of the vessel portion and/or to thwart detachment of the cap from the vessel portion. In accordance with yet a further aspect of this embodiment, the cap portion includes a sealing flange, which engages a top portion of the neck to form a rotatable seal.

In accordance with another embodiment of the invention, a system includes an assembly and a dispensable material within the assembly. In accordance with various aspects of this embodiment, the material includes one or more active ingredients for oral health care. In accordance with additional aspects of this embodiment, the material is configured to remain in an oral cavity for an extended period of time. In accordance with yet further embodiments of the invention, an assembly is formed by separately forming a vessel portion and a spout portion and subsequently coupling the vessel and spout portions to form an assembly. In accordance with various aspects of this embodiment, the vessel portion is formed using blow-molding and/or injection-molding techniques. In accordance with further aspects of this embodiment, the spout portion is formed using injection-molding techniques. In accordance with yet further aspects, the separately formed vessel and spout portions are sealably coupled together using interference-fit, snap-fit, thread, or lug fastening techniques.

In accordance with yet another embodiment of the invention, a system is formed by forming a vessel portion, forming a spout portion, filling the vessel portion with material, and sealably attaching the spout portion to the vessel portion to form the system.

In accordance with yet an additional embodiment of the invention, a method of using a system includes applying pressure to the vessel portion of a system to cause material to exit the system through the spout, which is rotatably and/or detachably coupled to the vessel portion.

### BRIEF DESCRIPTION OF THE DRAWINGS

The exemplary embodiments of the present invention will be described in connection with the appended drawing figures in which like numerals denote like elements and:

FIG. 1 illustrates an exemplary system for facilitating oral health care in accordance with an exemplary embodiment of the invention;

FIG. 2 illustrates another exemplary system for expulsion and application of a material with an exemplary embodiment of the invention;

FIG. 3 illustrates yet another system in accordance with various embodiments of the invention;

FIG. 4 illustrates a kit including a plurality of systems, in accordance with yet another embodiment of the invention; and

FIG. 5 illustrates a block diagram of an exemplary method for facilitating oral health care in accordance with an exemplary embodiment of the invention.

Elements in the figures are illustrated for simplicity and clarity and have not necessarily been drawn to scale. The dimensions of some of the elements in the figures may be exaggerated relative to other elements to help to improve understanding of embodiments of the present invention.

### DETAILED DESCRIPTION

The present invention provides an improved assembly for containing and dispensing material and a system including the assembly. As described in more detail below, the assembly provides a convenient, easy-to-use container and applicator for use with a variety of materials and applications. For example, the system can be used to contain and dispense oral care materials to a gum/tooth interface and surrounding areas within an oral cavity.

The invention is described herein in terms of various functional components, compositions and processing steps. It should be appreciated that such components and steps may be realized by any number of structural components and constituents configured to perform the specified functions. For example, the present invention may be used to dispense a variety of materials.

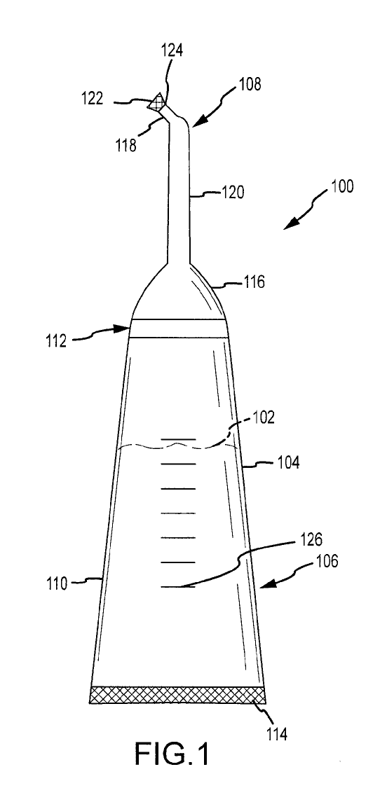

FIG. 1 illustrates a system 100 in accordance with various embodiments of the invention. In accordance with various exemplary aspects of the illustrated embodiment, system 100 includes a composition 102 and a container 104 for applying composition 102 to a surface.

Container 104 is configured for containment and temporary storage of composition 102 and for expulsion and application of composition 102 to a surface. Container 104 can be configured in various manners for application of composition 102 to a surface. For example, container 104 can comprise various sizes and volumes depending on treatment applications, and/or various shapes and configurations for facilitating delivery of composition 102 to a surface, depending upon, for example, the purpose for which composition 102 is being applied. In one case, container 104 is designed as a multi-dose applicator for convenient, repeated application of composition 102. In another case, system 100 may be configures as a single-dose applicator.

In accordance with specific examples of various embodiments, container 104 is configured to store about seven doses of a composition, about four doses, about two doses, or about one dose. However, the invention is not necessarily limited to these container sizes.

A dose size may vary in accordance with several factors, such as the particular ingredients or materials, the dilution of the composition, and the like. Exemplary dose sizes for purpose of illustration range from about 1 mg to about 6 mg, preferably about 2 mg to about 5 mg, and more preferably about 3 mg to about 4 mg.

With continued reference to FIG. 1, container 104 includes an expulsion or vessel portion 106 configured to contain or store composition 102 and to facilitate expulsion of composition 102, and an applicator portion 108 configured to receive composition 102 from expulsion portion 106 and to facilitate application or delivery of composition 102 to a surface.

In accordance with particular aspects of this embodiment, portion 106 is formed of a resiliently deformable material that is capable of retaining and returning to its original shape when not under pressure. In accordance with other aspects, portion 106 is formed of material that does return to its original shape. Exemplary resilient materials suitable for portion 106 include low density polyethylene material, high density polyethylene, medium density polyethylene, linear low density polyethylene, polyvinyl chloride, K resin, polyethylene terephthalate and copolyesters, polypropylene, surlyn, silicones and other thermostatics, metal or alloy, and the like. Portion 106 may be opaque, transparent, or semitransparent. An advantage of forming vessel portion 106 of transparent or semitransparent material is that an amount of material 102 within vessel portion 106 can be ascertained when the portion is formed of such material. Material used to form vessel portion 106 may also include UV protection additives, colorants, or the like, and is preferably FDA-approved material.

In accordance with various embodiments of the invention, expulsion or vessel portion 106 includes a resilient vial 110 and a neck 112. Resilient vial 110 acts as a reservoir for material 102 and also facilitates expulsion of material 102 from system 100 when pressure is applied to an external surface of vial 110. As illustrated, vial 110 may also include graduations 126 to, for example, illustrate and measure a number of doses used and/or a number of doses remaining. Neck 112 is configured to couple to applicator or spout portion 108.

Although illustrated as substantially tubular, with a sealed end 114, resilient vial 110 may be of any suitable shape. For example, vial 110 may be pyramidal, cone shaped, fluted, or have a rectangular cross section. Similarly, end portion 114 may be of any suitable shape, such as linear (e.g., a crimped or heat-sealed end) or the like. In general, preferred shapes of vial 110 conserve material used to form the vial, allow for easy dispensing of material 102, are easy to produce, and produce relatively little scrap during production.

Container 104 can also be configured to allow a user to suitably control the rate of expulsion into applicator portion 108. For example, in accordance with an exemplary embodiment, container 104 includes a transition region 116 to facilitate flow between vial 110 and spout 108. Transition portion 116 may be of any suitable shape such as frustro-conical, fluted, semi-spherical, and the like, and may be integral with vessel portion 106, spout portion 106, or neither.

Applicator portion 108 may be formed of any of the materials described above in connection with portion 106. Portion 108 is suitably configured for selective or otherwise controlled delivery of composition 102 to a target area, for example within an oral cavity. In accordance with various embodiments of the invention, applicator portion 108 is configured to couple (e.g., detachably or otherwise) to expulsion portion 106. Alternatively, portion 108 is configured as a molded or otherwise unitary structure with expulsion portion 106. When separately formed, portions 106 and 108 may be coupled using screwed, press-fit, clamped or other techniques to permanently, semi-permanently or removably attached portions 106 and 108.

In accordance with an exemplary embodiment, applicator portion 108 comprises a structure 120 to allow composition 102 to be forced through an applicator tip 118 and onto a surface. Structure 120 may be passive and substantially rigid to allow composition to flow from portion 106 to tip 118. Alternatively, structure 120 and/or applicator portion 108 may be configured as less-rigid to allow for expulsion of any remaining composition within applicator portion 108 to be squeezed or otherwise delivered or applied by applicator tip 118 onto a surface.

As illustrated structure 120 may form an angle of about zero degrees with respect to a centerline through expulsion portion 106. Alternatively, structure 120 may form other angles, ranging from about zero degrees to about 90 degrees. In further accordance with the illustrated embodiment, tip 118 forms an angle of about 45 degrees relative to the centerline of component 120; however, tip 118 may suitably form other angles, ranging between about 0 to about 90, about 20 to about 70, or about 30 to about 60 degrees relative to component 120.

Tip 118 is generally configured to facilitate placement and/or controlled flow of material dispensed from system 100. Tip 118 may be substantially cylindrical. Alternatively, tip 118 may have a square, rectangular, ellipse, or other cross-sectional configuration. Tip 118 may also include a weakened section 124, which may be formed, for example, by scarring a portion of tip 118. Weakened section 124 may facilitate rupturing tip 118 at weakened section 124, which in turn allows for a predicable cross section of tip 118 and thus a relatively predictable flow of material dispensed from system 100. In accordance with one particular example, tip 118 includes a substantially constant cross-section, which makes the flow more predictable, even if tip 118 is ruptured away from weakened area 124.

End portion 122 forms a sealed end at one end of tip 118. In accordance with various embodiments of the invention, end portion 122 is flat and wider at an exterior portion than an interior portion, such that end portion 122 is wider in at least one direction than tip 118. Having end portion 122 wider than tip 118 allows a user to grip end 122 to, for example, tear or sever tip 118 at weakened section 124. However, end 122 may be alternatively configured as, for example, a semisphere or other suitable shape. Alternatively, tip 118 and end portion 122 may be configured, such that end 122 can reattach to tip 118.

Spout portion 108 may be formed using a variety of materials, such as any of the materials described above in connection with vessel portion 106. However, because spout portion 108 may be formed separately from vessel portion 106, it need not be formed of the same material.

In accordance with one embodiment of the invention, vessel portion 106 and spout portion 108 are configured to sealably (and optionally rotatably) couple to each other. In the illustrated embodiment, portion 106 and 108 are threadably coupled to each other. In accordance with other embodiments, one of portions 106 and 108 includes a protrusion and the other of portion 106, 108 includes a recess to receive the protrusion, such that the protrusion and recess hold vessel portion 106 and spout portion 108 together, while optionally allowing the two portions to rotate about an axis, with respect to each other. In accordance with another embodiment of the invention, portions 106, 108 are configured to allow vessel portion 106 and spout portion 108 to be detachably coupled to each other. In this case, neck 112 and spout 108 may be snap-fit together as described above, or portions 106 and cap 108 may engage using lug or interference-fit technology to sealably attach to each other.

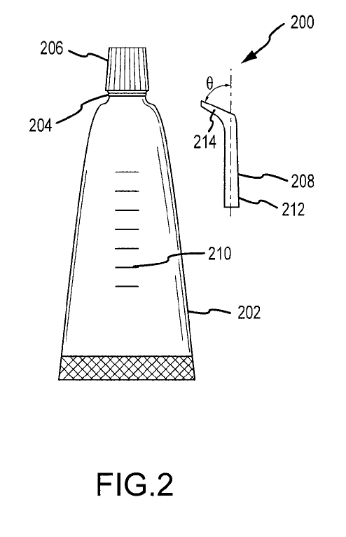

FIG. 2 illustrates another system 200 for use in accordance with additional embodiments of the invention. As illustrated, system 200 includes a vessel portion 202, including a neck 204, a cap 206, and a detachable applicator 208. System 200 is similar to system 100, except system 200 includes resealable cap 206 and detachable applicator 208, rather than applicator portion 108. System 200 may be formed of any of the materials noted above in connection with system 100, and may include graduations 210 to indicated a number of doses used and/or a number of remaining doses, as described above.

Cap 206 can be removably attached to vessel portion 202 using a variety of techniques. For example, cap 206 may be threadably attached to portion 202. Alternatively, cap 206 and portion 202 may be coupled using snap-fit, lug, interference-fit technology, or similar technologies. In accordance with one specific example of this embodiment, neck 204 includes exterior or male threads and cap 206 includes interior or female threads to threadably engage with neck 204.

Similarly, applicator portion 208 may couple to vessel 202 in a variety of ways, such as threaded, snap-fit, lug, interference-fit, or similar type connections. By way of particular example, applicator 208 interference-fits with an interior portion of neck 204.

Applicator 208 includes a first portion 212 and a second or tip portion 214. As illustrated, tip portion 214 is angled relative to a centerline alone the axis of first portion 212; however such is not required for practice of the present invention. Exemplary angles range from about zero to about ninety degrees, and one particular exemplary angle is about forty-five degrees relative to the centerline.

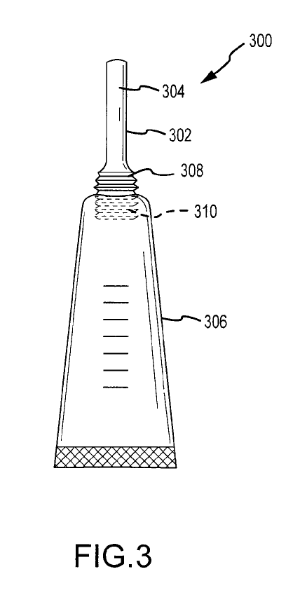

The presence of cap 108 or 206 within a system 100, 200, or 300 (described below with reference to FIG. 3) enables the system 100, 200, or 300 more successfully provide multiple doses of composition within a container of the system 100, 200, or 300. Cap 108 or 206 may be removed to enable system 100, 200, or 300 to dispense a composition during a single application, after which cap 108 or 206 may be replaced on system 100, 200, or 300 in order to preserve the integrity of the composition by, for example, preventing the composition from drying, hardening, or otherwise changing is viscosity or chemical properties as a result of prolonged exposure to an environment outside the system.

Further, when used to contain multiple doses, system 100, 200, or 300 may preferably include a container formed of a non-resilient, deformable material capable of establishing and maintaining a new shape after the shape of the container has been altered in conjunction with the application of one or more doses. For example, after a container of system 100, 200, or 300 is “squeezed” to apply a single dose, the container, formed of an exemplary metal alloy or plastic material, may maintain its new shape rather than resiliently returning to its shape that existed prior to “squeezing” the container. By not returning to its original shape, the interior portion of the container will not receive air from the external environment of the system 100, 200, or 300. By not receiving air from the external environment of the system 100, 200, or 300, and by securing a cap 108 or 206 to the system 100, 200, or 300 after applying one or more doses, the non-resilient, deformable container will prevent air from coming into prolonged contact with any remaining composition within system 100, 200, or 300. Thus, a non-resilient, deformable container and a cap 108 or 206 of system 100, 200, or 300 will provide system 100, 200, or 300 capable of preserving the integrity of any composition within the system 100, 200, or 300.

FIG. 3 illustrates yet another system 300 in accordance with additional embodiments of the invention. System 300 is similar to system 200, except system 300 includes an applicator 302, rather than applicator 208. Applicator 302 is similar to applicator 208, except applicator 302 does not include an angled tip. In other words, the entire portion, or multiple portions, of applicator 302 includes, shares, or share, a common axis along the length of the applicator 302. Applicator 302 includes male threads 308 that threadably engage corresponding female threads 310 within an interior portion of vessel portion 306.

Although not illustrated, systems in accordance with various embodiments of the invention may include tamper-resistant features. For example, system 100 may include a seal formed over neck 112, using, for example plastic or foil glued to or otherwise adhered to a top portion of neck 112. Alternatively, after spout portion 108 is attached to vessel portion 106, the two portions may be fused together using heat sealing and/or adhesive techniques.

In accordance with various exemplary embodiments, a composition (e.g., composition 102), suitable for use with systems (e.g., systems 100, 200, 300) of the present invention comprises one or more active ingredients and a viscous carrier. In this case, composition 102 is configured to maintain the active ingredient(s) in contact with a surface of an oral cavity for an extended period of time to allow the active ingredient(s) to remain in contact with the surface for an extended period.

Exemplary active ingredients suitable for use with systems of the invention include one or more of the following: cetylpyridinium chloride (CPC), dicalcium phosphate dehydrate, hydrogen peroxide, sanguinaria extract, sodium bicarbonate, sodium lauryl sulfate, stannous fluoride, sodium fluoride, sodium MFP (sodium monofluoride), zinc salts such as zinc chloride, zinc acetate, zinc citrate, and zinc gluconate, zinc oxide, alkyl dimethyl amine oxide, alkyl dimethyl glycine, eucalyptol, menthol, methyl salicylate, thymol, sodium citrate, peppermint oil, sage oil, polymethylsiloxane, polxamer, and stannous pyrophosphate. Other now known or hereafter devised actives may also be used. For example, any agent, which alone or in combination is able to prevent or alleviate the severity of problems associated with dentition may be utilized. Such may include anti-caries agents and the like; agents useful in reducing tooth hypersensitivity, such as potassium nitrate, strontium chloride and/or the like; and/or plaque and calculus reducing agents, such as, for example, chlorhexidine, quaternary ammonium compounds (e.g. benzethonium chloride, domphen bromide, etc.), triclosan, herbal compounds (e.g. sanguinarine), stannous salts, complex phosphates (e.g., pyrophosphates), SLS (e.g. sodium lauryl sulfate), hydrogen peroxide, and/or the like.

An amount of the active ingredient(s) for use within compositions suitable for uses with the invention varies in accordance with the dosage size, particular ingredient(s), United States Federal Food and Drug guidelines, and guidelines of like government agencies. In general, the active or actives selected will be used in a suitably effective amount, generally on the order of less than about 10 wt %, and more preferably 5 wt % or less. In particularly preferred compositions, the active ingredient(s) are present in an amount of about 0.001 wt % to about 1.5 wt %, within an amount of about 0.025 wt % to about 1.0 wt %, or even within an amount about 0.05 wt % to about 0.7 wt %. All percentages set forth herein are in weight percent of the total composition, unless otherwise indicated.

In accordance with one preferred exemplary embodiment, the active ingredient(s) include CPC. In one case, CPC is present in an amount of about 0.001% to about 1%, in an amount of about 0.01% to about 0.5%, or even in an amount of about 0.05% to about 0.25% or about 0.045% to about 0.1%. In accordance with another exemplary embodiment, the active ingredient(s) also include zinc gluconate. In one case, zinc gluconate is present in an amount of about 0.001% to about 1.5%, in an amount of about 0.01% to about 1.0%, or even in an amount of about 0.05% to about 0.75%.

In accordance with an exemplary embodiment, composition 102 also includes a thickener to obtain the desired viscosity. Suitable thickening agents include substances which increase the viscosity of composition 102, cause composition 102 to gel or coagulate, or the like, such as food-grade or pharmaceutical-grade thickeners, including, for example, hydroxyethylcellulose, hydroxypropyl methylcellulose, carrageenan, guar gum, methylcellulose, methyethylecellulose, acceptable non-ionic thickeners, and the like. The thickener may be present in an amount of about 0.01% to about 10%, in an amount of about 0.1% to about 7%, or even in an amount of about 1% to about 5% or about 0.5% to about 3%.

Composition 102 may also include a humectant such a glycerin, which may be present in an amount of about 0.01% to about 15%, preferably about 0.1% to about 10%, and more preferably about 1% to about 7%. When used, the humectant may facilitate maintaining composition 102 in a liquid form and may help maintain a desired viscosity. In accordance with specific aspects, glycerin facilitates maintaining one or more of the active ingredients in an ionic form and/or facilitates the transport of the active ingredients through composition 102.

The composition may also include a diluent. Exemplary diluents suitable for use with the present composition include sorbitol, xylitol, mannitol, water, alcohols, and oils. In accordance with particular examples of the invention, the composition includes purified water in an amount of about 80% to about 99%, preferably about 85% to about 95%, and more preferably about 88% to about 92%.

Composition 102 may also include sugar alcohols such as sorbitol and xylitol, monnital, lactitol, and the like that act as a sweetener and also as a humectant and/or emulsifier and/or diluent. When used, sorbitol or other sugar alcohol can be present in an amount of about 0.001% to about 5%, in an amount of about 0.01% to about 0.1%, or even in an amount of about 0.025% to about 0.075%.

Composition 102 may also include a natural or artificial sweetener such as sucralose, saccharin (e.g., sodium or calcium), cyclamates, ace-k, or aspartame which, when included in composition 102, can be present in an amount of about 0.001% to about 1.5%, in an amount of about 0.01% to about 1%, or even in an amount of about 0.25% to about 0.75 Colorants may also be added to composition 102. For example, composition 102 can include colorants, such that when composition 102 is applied to or proximate the gingiva, composition 102 has a color indicative of healthy gingiva—e.g., composition 102 can be pink in color. Such a composition having a color indicative of healthy gingiva can provide added incentive to users to continue using composition 102, which in turn promotes improved health care and hygiene. Colorants may be present in any desired amount. For example, the colorants may include Red #33 and/or Red #40, available from Pylam in an amount of about 0.000005% to about 1%, preferably about 0.00050% to about 0.5%, and more preferably about 0.001% to about 0.1%.

Additionally and/or alternatively, colorants may be added to indicate a flavor. For example, green and blue colorants can be used to indicate mint flavors, and reds can be used to indicated cinnamon and the like. In accordance with some examples, any suitably approved colorant may be used. Examples include FD&C Blue #1, D&C Green #5, FD&C Yellow #5, and FD&C Yellow #6.

Composition 102 may also include other additives or flavorants such as cinnamon oil, clove oil, mints, anise, citrus, fruits, and the like, which, when included in the formula are present in an amount of about 0.01% to about 2%, in an amount of about 0.01% to about 1%, or even in an amount about of about 0.1% to about 0.5%.

Essential oils such as cinnamon bark oil and clove bud oil may be particularly advantageous because they exhibit additional desirable qualities. For example, cinnamon bark oil exhibits antibacterial, antiseptic, antiviral, antispasmodic, antifungal, sedative and analgesic properties and clove bud oil has local anesthetic, antiseptic, antibacterial, and stimulating properties.

In accordance with various embodiments, composition 102 is configured to maintain the composition in contact with a surface for an extended period of time, which has several advantages over traditional compositions. Composition 102 preferably exhibits good microadhesion, and moreover, composition 102 preferably is quite viscous. As such, in general, relatively small amounts of composition 102 and consequently the active agent(s) can be used to effectively provide oral health care or treatment. Additionally, this configuration allows for relatively select placement of the composition on a surface.

Exemplary compositions have a viscosity greater than about 20,000 cp, preferably greater than 30,000 cp, and more preferably greater than about 35,000 cp. By way of more particular examples, the viscosity of compositions range from about 20,000 cp to about 250,000 cp, preferably about 25,000 cp to about 100,000 cp, and more preferably about 30,000 cp to about 50,000 cp, and yet more preferably about 35,000 cp to about 45,000 cp. The viscosity values as set forth herein are measured using a Brookfield, Model DV-II+Pro viscometer using spindle #6, 10 RPM for 90 seconds at 25 C.

In accordance with other exemplary embodiments, composition 102 includes multiple active ingredients in a carrier. For example, composition 102 can include a plurality of any active ingredients and a carrier in the weight percents disclosed herein. Composition 102 may also include any of the optional ingredients, such as thickeners, sweeteners, additives, flavorants, and colorants as set forth herein. For example, in accordance with an exemplary embodiment, composition 102 includes CPC and zinc gluconate as the active ingredients, wherein the CPC is present in an amount of about 0.001% to about 1%, in an amount of about 0.01% to about 0.5%, or even in an amount of about 0.05% to about 0.25% or about 0.045% to about 0.1%; and wherein the zinc gluconate is present in an amount of about 0.001% to about 1.5%, in an amount of about 0.01% to about 1.0%, or even in an amount of about 0.05% to about 0.75%. In accordance with additional embodiments, the composition includes zinc and/or CPC, for example in the quantities noted above, and one or more additives as a second active ingredient.

In accordance with other exemplary embodiments, composition 102 includes one or more active ingredients and a colorant indicative of healthy gingival, wherein the color of composition 102 is more than merely decorative; it also serves the function of encouraging those that use the product to continue to use the product because there is an immediate appearance, upon application of composition 102, that healthy gingival is achieved. Additionally or alternatively, the color may be indicative of a flavor.

A pH of composition 102 may vary in accordance with a particular application. In accordance with various embodiments of the invention, the pH is between about 4-10, preferably about 4-7, and more preferably about 5-5.4.

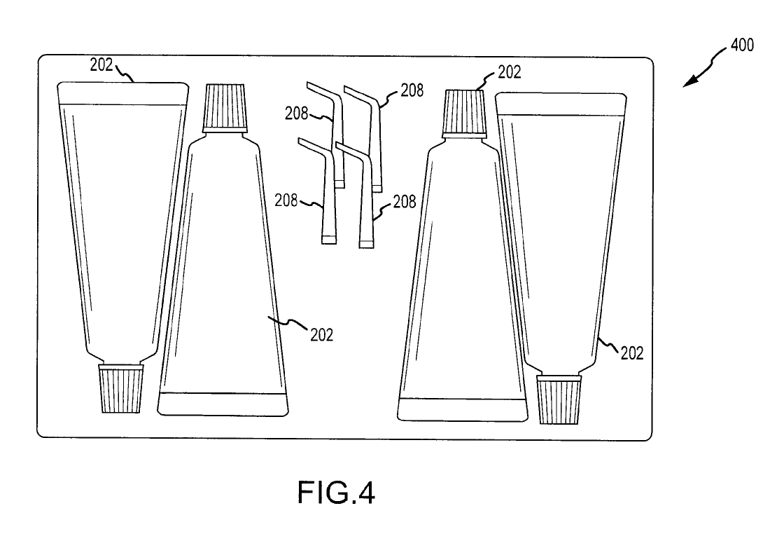

FIG. 4 illustrates a kit 400, including multiple systems, in accordance with yet additional embodiments of the invention. As illustrated, kit 400 includes four systems 200. The four systems 200 within kit 400, as shown, include four vessel portions 202 and four detachable applicators 208. Kits in accordance with other embodiments of the invention may include any number, e.g., 1, 2, 4, 7, 10, of systems and may include any portion or whole of any system described herein in any combination with any portion or whole of any other system, including systems 100, 200, and 300.

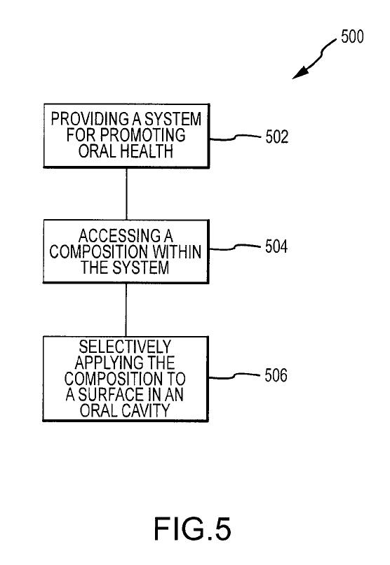

In accordance with further exemplary embodiments, with reference to FIG. 5, as well as continuing reference to FIGS. 1-4, a method 500 of using a system includes providing a system (e.g., system 100), including a composition (e.g., composition 102) (step 502) accessing the composition within the container (step 504), and selectively applying the composition to a surface (step 506).

Providing a system in accordance with step 502 can include any method now known or hereinafter devised for filling a container with a fluid. With reference to FIG. 1, composition 102 can suitably be filled in one end of container 104 and then sealed to maintain composition 102 within container 104. Alternatively, with reference to FIG. 2, vessel 202 may be filled with composition 102 and then cap 206 sealably attached to vessel 202. In addition, providing composition 102 within container 104 may include providing a single and/or daily dose of composition 102, or multiple doses of composition 102.

Accessing composition 102 within container 104 suitably comprises removal of an access or closure device or component from container 104. For example, in accordance with an exemplary embodiment, accessing composition 102 within container 104 comprises detachably removing an access component, e.g., end portion 122, to provide an access to the composition.

Selectively applying composition 102 to a surface can suitably include expulsing or otherwise forcing or delivering composition 102 from a vial 10 to applicator portion 108 of container 104. For example, in accordance with an exemplary embodiment, composition 102 can be “squeezed” from an expulsion portion 106, into an applicator portion 108, through an applicator tip 118 and onto a targeted region of oral cavity surface. In accordance with various embodiments of the invention, the system does not require any additional additives or solutions for use. That is, the compositions can be applied directly to a surface without diluting or the like. Further, the compositions can be applied without additional devices such as cups or the like.

The present invention has been described above with reference to various exemplary embodiments. However, those skilled in the art will recognize that changes and modifications may be made to the exemplary embodiments without departing from the scope of the present invention. For example, the various operational steps, as well as the components for carrying out the operational steps, may be implemented in alternate ways depending upon the particular application or in consideration of any number of cost functions associated with the operation of the system, e.g., various steps may be deleted, modified, or combined with other steps. These and other changes or modifications are intended to be included within the scope of the present invention, as set forth in the following claims.

1. A system for dispensing material, the system comprising:
a cap;
a container comprising a vessel portion comprising a vial and neck, wherein the vessel portion is configured to store doses of a composition and the neck is configured to engage with the cap; and
a detachable applicator coupled to the vessel portion, wherein the applicator is configured to couple to the neck and apply the composition to a surface,
wherein the detachable applicator includes a first portion and a second portion wherein the first portion is configured to couple to the neck and includes a centerline along the axis of the first portion, and wherein the second portion is angled from about zero degrees to less than ninety degrees relative to the centerline along the axis of the first portion.

2. (canceled)

3. The system for dispensing material according to claim 1, wherein the second portion is angled from about zero degrees to about ninety degrees relative to the centerline along the axis of the vessel portion.

4. The system for dispensing material according to claim 1, wherein the second portion is angled at about forty-five degrees relative to the centerline along the axis of the first portion.

5. The system for dispensing material according to claim 1, wherein the applicator is coupled to the vessel portion by interference fit.

6. The system for dispensing material according to claim 1, wherein the applicator includes male threads, wherein the vessel portion includes female threads, and wherein the detachable applicator is coupled to the vessel portion when the male threads are screwed into the female threads.

7. (canceled)

8. The system for dispensing material according to claim 1, wherein the vessel portion is formed of a deformable material.

9. The system for dispensing material according to claim 1, wherein the vessel portion is formed of a resilient material.

10. The system for dispensing material according to claim 9, wherein the resilient material includes at least one of low density polyethylene material, high density polyethylene, medium density polyethylene, linear low density polyethylene, polyvinyl chloride, K resin, polyethylene terephthalate and copolyesters, polypropylene, surlyn, silicones and other thermostatics, metal, and alloy.

11. The system for dispensing material according to claim 1, wherein the applicator is coupled to the vessel portion using screwed, press-fit, clamped, or other techniques.

12. The system for dispensing material according to claim 11, wherein the vessel portion includes multiple graduations to illustrate and measure the number of doses of composition applied and doses of composition remaining in the container.

13. A disposable, self-contained material dispensing system, the system comprising:
a composition; and
a container configured for sealable storage of the composition, said container comprising:
a vessel portion, wherein the vessel portion includes an integral transition portion and is configured to store the composition; and
an applicator sealably coupled to the transition portion, wherein the applicator is configured to apply through forcible expulsion the composition to a surface, wherein the applicator includes a first portion and a second portion, wherein the first portion includes a centerline along the axis of the first portion, and wherein the second portion is angled from about twenty degrees to about seventy degrees relative to the centerline along the axis of the first portion, and wherein the applicator further comprises a sealed end severable at a weakened section.

14. The system of claim 13, wherein the vessel portion includes multiple graduations to measure a number of doses of composition remaining.

15. The system of claim 14, wherein the container is configured to contain about seven doses of composition.

16. The system of claim 15, wherein a composition dose size is within at least one of the following ranges: from about 1 mg to about 6 mg, from about 2 mg to about 5 mg, and from about 3 mg to about 4 mg.

17. A kit comprising:
a plurality of systems, wherein each system container comprises:
a composition configured to improve oral health when applied to an oral cavity surface; and
a container comprising:
a vessel portion encapsulating the composition; and
an applicator sealably and rotatable coupled to the vessel portion, wherein the applicator is configured to rotate about a centerline along the axis of the vessel portion, and wherein the applicator further comprises a sealed end severable at a weakened section.

18. The kit of claim 17, wherein each container is configured to apply multiple doses of the composition to the oral cavity surface.

19. The system of claim 18, wherein vessel portion includes at least one graduation to illustrate and measure the number of doses of composition remaining.
